(19) United States
(12) Patent Application Publication
(10) Pub. No.: US 2026/0012973 A1
(43) Pub. Date: Jan. 8, 2026

(54) METHODS FOR TRANSMISSION IN HARDWARE IMPAIRMENT-BASED INTELLIGENT REFLECTING SURFACE (IRS)-ASSISTED NON-ORTHOGONAL MULTIPLE ACCESS (NOMA) NETWORK

(71) Applicant: CHONGQING UNIVERSITY OF POSTS AND TELECOMMUNICATIONS, Chongqing (CN)

(72) Inventors: Qilie LIU, Chongqing (CN); Jiacheng FANG, Chongqing (CN); Yanan XIN, Chongqing (CN); Long WANG, Chongqing (CN); Yicun LIU, Chongqing (CN); Fengfan YANG, Chongqing (CN); Qian LIU, Chongqing (CN); Jingcheng LIU, Chongqing (CN); Dong HUANG, Chongqing (CN); Shuke DU, Chongqing (CN)

(73) Assignee: CHONGQING UNIVERSITY OF POSTS AND TELECOMMUNICATIONS, Chongqing (CN)

(21) Appl. No.: 19/322,649

(22) Filed: Sep. 8, 2025

Related U.S. Application Data
(63) Continuation of application No. PCT/CN2024/079956, filed on Mar. 4, 2024.

(30) Foreign Application Priority Data
Oct. 7, 2023 (CN) 202311296596.X

(51) Int. Cl. H04W 72/543; H04W 72/044

(52) U.S. Cl. CPC H04W 72/543; H04W 72/0473

(57) ABSTRACT

The present disclosure relates to a method for transmission in a hardware impairment-based intelligent reflecting surface (IRS)-assisted non-orthogonal multiple access (NOMA) network, including: constructing an NOMA network system assisted by an IRS; constructing a base station transmission power minimization model based on a user quality of service (QoS) constraint, a successive interference cancellation (SIC) constraint, and a reflective phase shift constraint; solving the base station transmission power minimization model to obtain an optimal transmission scheme, and controlling the NOMA network system to transmit according to the optimal transmission scheme; the base station transmission power minimization model including an active beamforming vector optimization sub-problem and a passive beamforming vector optimization sub-problem.

### CROSS-REFERENCE TO RELATED APPLICATIONS

This application is a Continuation of International Application No. PCT/CN2024/079956, filed on Mar. 4, 2024, which claims priority of Chinese Application No. 202311296596.X, filed on Oct. 7, 2023, the entire contents of which are hereby incorporated by reference.

### TECHNICAL FIELD

The present disclosure relates to the field of wireless communication technology, and in particular, to a method for transmission in a hardware impairment-based IRS-assisted NOMA network.

### BACKGROUND

In order to meet the needs of the development of the mobile Internet and the Internet of Everything, the future 6G network will support holographic and high-precision communications. For this reason, the need to deal with extremely large amounts of data in near-real time will require communication systems to face problems such as huge energy consumption and communication instability. In this context, how to realize low-power transmission on the basis of improving the robustness of the communication system has become a problem that needs to be studied in the field of wireless communication. In recent years, non-orthogonal multiple access (NOMA) technology has been recognized as an effective technique to enhance spectrum efficiency. Specifically, NOMA can utilize superimposition coding and successive interference cancellation (SIC) to serve a plurality of users in the same resource block, but NOMA networks are still prone to problems such as unstable communications. An intelligent reflecting surface (IRS) is considered as one of the key technologies for future wireless communication systems. IRS is a plane composed of a large number of reconfigurable passive reflective elements, each of which is capable of independently changing the amplitude and phase of the incident signal, thus effectively improving the signal propagation environment and increasing utilization of the spectrum and its robustness.

At present, the use of RF technology and large-scale base stations can solve some of the above problems, but due to the active nature of RF technology, it does not meet the requirements of current low energy consumption, and large-scale base stations face the same problem. In the prior art, some cases combining intelligent reflecting surfaces with non-orthogonal multiple access techniques have been proposed. For example, the IRS-assisted uplink NOMA network model maximizes the sum rate of users under a user quality of service (QOS) constraint and reveals the relationship between the count of IRS reflective elements and the user sum rate, and the integrated multicast and unicast IRS-assisted NOMA downlink network system maximizes the unicast data rate by optimizing the passive beamforming vector of the IRS while guaranteeing the multicast data rate.

However, all the above studies assume perfect channel state information (CSI) and transceiver hardware impairments (HWI), which are not achievable in practice. Imperfect CSI exists during signal propagation due to issues such as occlusion that can interfere with the signal propagation environment, as well as CSI update delays that has an impact on channel estimation. Moreover, in real-world application scenarios, problems such as transceiver hardware aging, oscillator noise, and low-resolution digital-to-analog converters tend to occur, which results in hardware impairments in both the base station and the user equipment.

Therefore, it is desirable to provide a method for transmission in a hardware impairment-based IRS-assisted NOMA network, which realizes low-power transmission with consideration of the HWI and the imperfect CSI, and can minimize energy consumption while ensuring system robustness.

### SUMMARY

One or more embodiments of the present disclosure provide a method for transmission in a hardware impairment-based intelligent reflecting surface (IRS)-assisted non-orthogonal multiple access (NOMA) network, comprising: constructing an NOMA network system assisted by an IRS; constructing a base station transmission power minimization model based on a user quality of service (QOS) constraint, a successive interference cancellation (SIC) constraint, and a reflective phase shift constraint; solving the base station transmission power minimization model to obtain an optimal transmission scheme, and controlling the NOMA network system to transmit according to the optimal transmission scheme; including: constructing a composite channel uncertainty model, which is represented as:

$$\begin{matrix}{H}_{k} = {H}_{k} + Δ {H}_{k} \\ {‖ {ΔH}_{k} ‖}_{F} \leq {ξ}_{h , k}\end{matrix} \}$$

wherein Hₖ denotes a composite channel matrix from a base station to a user k, Ĥₖ denotes an estimation value of the composite channel matrix, ΔHₖ denotes an estimation error of the composite channel matrix, and ξ_{h,k} denotes a radius value of an error region; rewriting the base station transmission power minimization model based on the composite channel uncertainty model; decomposing the rewritten base station transmission power minimization model into an active beam forming vector optimization sub-problem and a passive beamforming vector optimization sub-problem; the active beamforming vector optimization sub-problem being expressed as:

$$\begin{matrix}{min}_{\{ {w}_{k} \} , {η}_{h} , {μ}_{h}} {\sum }_{k = 1}^{K} {‖ {w}_{k} ‖}^{2} \\ s . t . C 2 : {R}_{j \to k} \geq {R}_{k \to k} , Ω ( j ) \geq Ω ) k ) \\ C 4 : [ \begin{matrix}{η}_{h , k} {I}_{( L \times N ) + {A}_{k , k}} & {a}_{k , k} \\ {a}_{k , k}^{T} & {C}_{k}\end{matrix} ] ≽ 0 \\ C 5 : [ \begin{matrix}{λ}_{k} - ( 1 + {α}_{a , k} ) {δ}^{2} & {e}^{H} {H}_{k} {ω}_{k} & {0}_{1 \times N} \\ {ω}_{k}^{H} e {\hat{H}}_{k}^{H} & {I}_{( K\_K )} & {ξ}_{h , k} {ω}_{k}^{H} \\ {0}_{N \times 1} & {ξ}_{h , k} {ω}_{k} & {μ}_{h , k} {I}_{N}\end{matrix} ] ≽ 0 \\ C 6 : {η}_{h} \geq 0 , {μ}_{h} \geq 0\end{matrix}$$

wherein wₖ denotes an active beamforming vector sent by the base station to the user k, K denotes a total count of users, R_{k→k} denotes a decoding rate at which the user k decodes its own signal, R_{j→k} denotes a decoding rate at which a user j decodes the signal of the user k, Ω(j) denotes a decoding order of the user j, Ω(k) denotes a decoding order of the user k, I_{(L×N)} denotes a unit matrix of order L×N, A_{k,k}, a_{k,k} and Cₖ denote a first intermediate parameter, a second intermediate parameter, and a third intermediate parameter, respectively, a_{a,k} denotes a scaling coefficient of hardware impairment (HWI) at a receiving end of the user k, λₖ denotes an interference-plus-noise power of the user k, δ denotes a variance of Gaussian white noise, e denotes a passive beamforming vector of the IRS, Ĥₖ denotes the estimation value of the composite channel matrix, ωₖ denotes an active beamforming matrix, 0_{1×N} denotes a zero matrix of order 1×N, I_{(K-k)} denotes a unit matrix of order K-k, ξ_{h,k} denotes the radius value of the error region, I_{N} denotes a unit matrix of order N×N, ηₕ=[n_{h,1}, . . . , nh,K]^{T}≥0 denotes a first relaxation variable, η_{h,k} denotes a first relaxation variable for the user k, μₕ=[μ_{h,1}, . . . , μ_{h,K}]^{T}≥0 denotes a second relaxation variable, μ_{h,k} denotes a second relaxation variable for the user k; the passive beamforming vector optimization sub-problem being represented as:

$$\begin{matrix}{max}_{e , {η}_{k} , {μ}_{k} , p} {\sum }_{k = 1}^{K} {p}_{k} \\ s . t . C 3 : {\vert {e}_{1} \vert}^{2} = 1 , {e}_{1} ∈ e \\ C 4 : [ \begin{matrix}{η}_{h , k} {I}_{( L \times N ) + {A}_{k , k}} & {a}_{k , k} \\ {a}_{k , k}^{T} & {C}_{k}\end{matrix} ] ≽ 0 \\ C 5 : [ \begin{matrix}{λ}_{k} - ( 1 - {α}_{a , k} ) {σ}^{2} & {e}^{H} {H}_{k} {ω}_{k} & {0}_{1 \times N} \\ {ω}_{k}^{H} e {\hat{H}}_{k}^{H} & {I}_{( K - K )} & {ξ}_{h , k} {ω}_{k}^{H} \\ {0}_{N \times 1} & {ξ}_{h . k} {ω}_{k} & {μ}_{h , k} {I}_{N}\end{matrix} ] ≽ 0 \\ C 6 : {η}_{h} ≽ 0 , {μ}_{h} ≽ 0 \\ C 8 : p ≽ 0 \\ C0 : ln ( {\vert {e}^{H} {H}_{k} {w}_{k} \vert}^{2} ) - ln ( {\sum }_{Ω ( i ) > Ω ( k )} {\vert {e}^{H} {H}_{k} {w}_{i} \vert}^{2} + {Λ}_{k} ) \\ - ln ( {\vert {e}^{H} {H}_{j} {w}_{k} \vert}^{2} ) + ln ( {\sum }_{Ω ( i ) > Ω ( k )} {\vert {e}^{H} {H}_{j} {w}_{i} \vert}^{2} + {Λ}_{j} ) \leq 0 , Ω ( j ) > Ω ( k )\end{matrix}$$

wherein pₖ denotes an SINR residual for the user k, e denotes the passive beamforming vector of the IRS, e₁ denotes an l-th element of the passive beamforming vector of the IRS, p denotes a SINR residual matrix, Hₖ denotes the composite channel matrix from the base station to the user k, wᵢ denotes an active beamforming vector sent by the base station to a user i, Λₖ denotes a total noise power of the user k, and Hⱼ denotes a composite channel matrix from the base station to the user j; and solving the active beamforming vector optimization sub-problem and the passive beamforming vector optimization sub-problem to obtain the optimal transmission scheme.

### BRIEF DESCRIPTION OF THE DRAWINGS

The present disclosure will be further illustrated by way of exemplary embodiments, which will be described in detail through the accompanying drawings. These embodiments are not limiting, and in these embodiments, the same numbering denotes the same structure, wherein:

FIG. 1 is a flowchart of an exemplary process for transmission in a hardware impairment-based IRS-assisted NOMA network according to some embodiments of the present disclosure;

FIG. 2 is a schematic diagram of an application scenario of a hardware impairment-based IRS-assisted NOMA network system according to some embodiments of the present disclosure;

FIG. 3 is a flowchart of an exemplary process for determining an optimal transmission scheme according to some embodiments of the present disclosure;

FIG. 4 is another flowchart of an exemplary process for determining an optimal transmission scheme according to some embodiments of the present disclosure;

FIG. 5 is a schematic diagram of a simulation reference model according to some embodiments of the present disclosure; and

FIG. 6 is a schematic diagram of variations of feasibility rates of different algorithms with a scaling coefficient of HWI according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the terms “system,” “unit,” and/or “module” used herein are one method to distinguish different components, elements, parts, sections, or assemblies of different levels in ascending order. However, the terms may be displaced by other expressions if they may achieve the same purpose.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

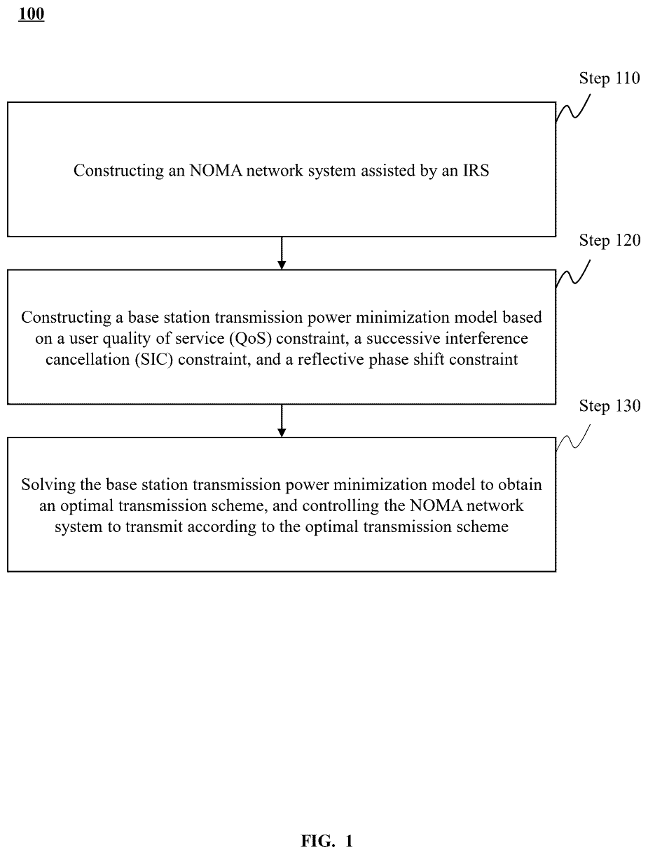

FIG. 1 is a flowchart of an exemplary process for transmission in a hardware impairment-based IRS-assisted NOMA network according to some embodiments of the present disclosure. As shown in FIG. 1, process 100 includes the following steps. In some embodiments, the process 100 may be executed by a processor.

In some embodiments, the processor is configured to manage data resources and process involved data and/or information from the IRS-assisted NOMA network system. In some embodiments, the processor may include a central processing unit (CPU), an application-specific integrated circuit (ASIC), a microprocessor, etc., or any combination thereof.

Step 110: constructing an NOMA network system assisted by an IRS.

The intelligent reflecting surface (IRS) refers to an adjustable lens plane configured to change a reflection direction of a radio wave.

The non-orthogonal multiple access (NOMA) network system refers to a wireless communication network that uses non-orthogonal multiple access technology to serve a plurality of users within the same time-frequency resources.

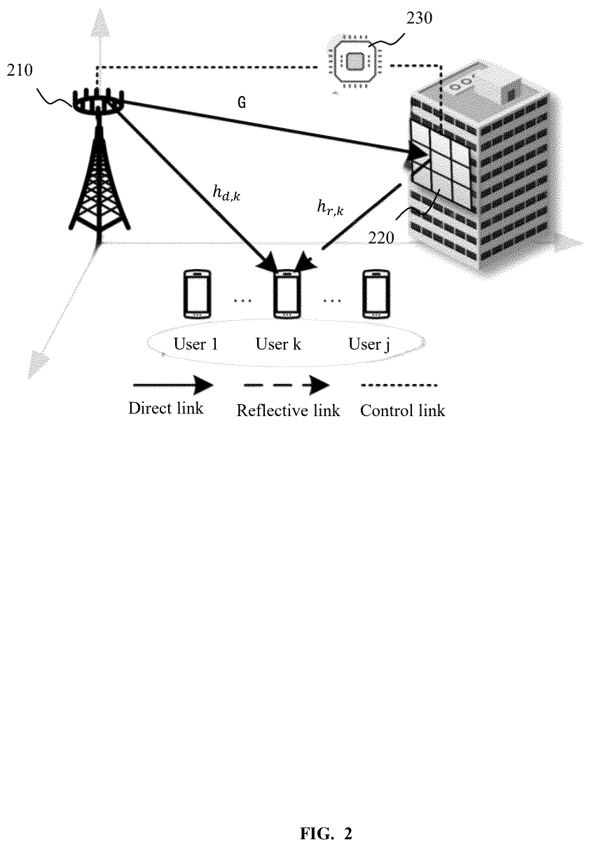

FIG. 2 is a schematic diagram of an application scenario of a hardware impairment-based IRS-assisted NOMA network system according to some embodiments of the present disclosure.

In some embodiments, as shown in FIG. 2, the hardware impairment-based IRS-assisted NOMA network system (hereinafter referred to as a NOMA network system) may include a base station 210 equipped with a plurality of antennas, an intelligent reflecting surface (IRS) 220, and a plurality of single-antenna user terminals. In some embodiments, the IRS 220 is equipped with a plurality of reflection units.

The base station (BS) refers to a fixed device for receiving and transmitting signals in wireless communication. The base station may connect a terminal device to a network. For example, the base station may include a 5G signal tower, an emergency communication vehicle, and a drone overhead base station.

The reflection unit refers to a single passive element on the IRS that may independently modulate a phase and an amplitude of an electromagnetic wave.

The single-antenna user terminal refers to a wireless terminal equipped with only one antenna for transmitting and receiving. For example, the single-antenna user terminal may include an ordinary cell phone, a smart bracelet, and a shared bicycle lock. Merely by way of example, as shown in FIG. 2, the single-antenna user terminal includes user terminal 1, user terminal k, user terminal j, etc.

In some embodiments, signals sent by the base station may be transmitted to the single-antenna user (i.e., the user described later) through a plurality of channel matrices. For example, the plurality of channel matrices include a channel matrix from the base station to the IRS, a channel matrix from the IRS to the user, and a channel matrix from the base station to the user.

In some embodiments, the channel matrix from the base station to the IRS is G E [symbol] ^{L×N}, the channel matrix from the IRS to the user is h_{r,k}∈ [symbol] ^{L×1}, and the channel matrix from the base station to the user is h_{d,k}∈ [symbol] ^{N×1}. In some embodiments, a phase shift matrix of the IRS is denoted by ϕ=diag(θ)∈ [symbol] ^{L×L}, wherein θ=[exp^{jθ}^{₁}, . . . , exp^{jθ}^{ₗ}, . . . , exp^{jθ}^{_{L}}], θₗ=[0,2π] denotes a reflective phase shift of an l-th reflection unit of the IRS. In some embodiments, the signals transmitted by the base station 210 may be transmitted directly to the single-antenna user. In some embodiments, the signals emitted by the base station 210 may be transmitted to the single-antenna user via the IRS 220. More descriptions regarding G, h_{r,k}, h_{d,k}, L, θ, ϕ and the phase shift matrix may be found in below and related descriptions thereof.

In some embodiments, the hardware impairment-based IRS-assisted NOMA network system further includes a microcontroller 230. The microcontroller 230 is set between the IRS and the base station. The microcontroller 230 is configured to dynamically adjust a phase offset of the reflection unit to enhance the transmission performance of the non-orthogonal multiple access network.

In some embodiments, transmission links of a signal in the NOMA network system as shown in FIG. 2 include a direct link, a reflective link, and a control link. The direct link refers to a link in which the signal from the base station is transmitted directly to the single-antenna user terminal. The reflective link refers to a link where the IRS reflects the signal from the base station to the single-antenna user terminal. The control link refers to a link in which the microcontroller controls the base station and the IRS.

In an actual IRS-assisted NOMA network system, some embodiments of the present disclosure consider HWI between the BS and the user equipment due to issues such as power amplifier errors, oscillator noise, etc. Simultaneously, factors including residual SIC errors and wireless channel randomness lead to the consideration of imperfect channel state information (CSI) when establishing the system.

In some embodiments, the processor may construct the NOMA network system based on the base station with the plurality of antennas, the IRS, and the plurality of single-antenna users.

Step 120: constructing a base station transmission power minimization model based on a user quality of service (QOS) constraint, a successive interference cancellation (SIC) constraint, and a reflective phase shift constraint.

The user QoS constraint refers to a constraint that ensures user requirements and expectations are met during data transmission. For example, the user QoS constraint may be that an actual decoding rate for each user is greater than or equal to a minimum rate threshold specified by the system. In some embodiments, the user QoS constraint may be expressed as C1, where C1 satisfies the following equation:

$$\begin{matrix}C 1 : {R}_{k \to k} \geq {R}_{min} \\ {R}_{k \to k} = {log}_{2} ( 1 + {SINR}_{k \to k} ) \\ {SINR}_{k \to k} = \frac{{\vert {e}^{H} {H}_{k} {w}_{k} \vert}^{2}}{{\sum }_{Ω ( i ) > Ω ( k )} {\vert {e}^{H} {H}_{k} {w}_{i} \vert}^{2} + 𝔼 \{ {n}_{k} {n}_{k}^{*} \}}\end{matrix}$$

where R_{k→k} denotes a decoding rate of a user k, Rₘᵢₙ denotes the user minimum rate threshold, SINR_{k→k} denotes a signal-to-noise ratio for the user k to decode its own signal; e denotes a passive beamforming vector of the IRS, e=[θ 1]^{H}, θ=[exp^{jθ}^{₁}, . . . , exp^{jθ}^{ₗ}, . . . , exp^{jθ}^{_{L}}], L denotes a total count of the reflection units, θ_{L} denotes the phase shift matrix of the reflection units L, and H denotes a conjugate transpose matrix;

$${H}_{k} = [ \begin{matrix}diag ( {h}_{r , k}^{H} ) G \\ {h}_{d , k}^{H}\end{matrix} ]$$

denotes the composite channel matrix from the BS to the user k,

$${h}_{d , k}^{H}$$

denotes the channel matrix from the BS to the user k,

$${h}_{r , k}^{H}$$

denotes the channel matrix from the IRS to the user k, and G denotes the channel matrix from the BS to the IRS; wᵢ denotes an active beamforming vector from the BS to a user i; wₖ denotes an active beamforming vector from the BS to the user k, nₖ denotes total noise received by the user k, nₖ=(e^{H}Hₖ)nₜ+n₀+n_{a,k}, n*ₖ denotes a conjugate of nₖ, nₜ denotes noise caused by hardware impairments (HWI) at the BS, and n₀ denotes additive white noise at a receiving end of the user k.

The decoding rate refers to a data transmission rate at which information may be stably recovered.

The user minimum rate threshold refers to a minimum value of the decoding rate for the user that ensures proper signal transmission. In some embodiments, the user minimum rate threshold may be set empirically by those skilled in the art.

The passive beamforming vector refers to a set of correlation coefficient vectors of the reflection units in the IRS. For example, the passive beamforming vector may include a vector including reflection angles of the plurality of reflection units and a vector including phases of the plurality of reflection units.

The phase shift matrix refers to a diagonal matrix including phase modulation values of each reflection unit in the IRS.

The conjugate transpose matrix refers to a matrix obtained by taking a complex conjugate of the matrix and then transposing the complex conjugate of the matrix.

The composite channel matrix refers to a matrix consisting of all communication channels by which a signal is transmitted from the BS to the user.

The active beamforming vector refers to a beam weighting vector sent by the BS to a specific user. For example, the active beamforming vector may include a signal frequency vector and a phase vector of the BS. The signal frequency vector of the BS may be preset based on user requirements or experience. The phase vector of the BS may be preset based on the experience.

The additive white noise refers to random noise with a constant power spectral density and is independently additive to the signal. The additive white noise may be obtained by measurement.

The successive interference cancellation constraint refers to a constraint that eliminates mutual interference between the signals during signal processing. For example, the successive interference cancellation constraint may be that the decoding rate of a signal delivered by a later-decoded user to an earlier-decoded user is not lower than the decoding rate of the earlier-decoded user. In some embodiments, the successive interference cancellation constraint may be expressed as C2, where C2 satisfies the following equation:

$$\begin{matrix}C 2 : {R}_{j \to k} \geq {R}_{k \to k} , Ω ( j ) > Ω ( k ) \\ {SINR}_{j \to k} = \frac{{\vert {e}^{H} {H}_{j} {w}_{k} \vert}^{2}}{{\sum }_{Ω ( i ) > Ω ( k )} {\vert {e}^{H} {H}_{j} {w}_{i} \vert}^{2} + 𝔼 \{ {n}_{j} {n}_{j}^{*} \}}\end{matrix}$$

where SINR_{j→k} denotes the signal-to-noise ratio of the user j decoding the signal of the user k, R_{j→k} denotes the decoding rate of the user j decoding the signal of the user k; Ω(j) denotes a decoding order of the user j, Q (k) denotes a decoding order of the user k; Ω(i) denotes a decoding order of the user i; nⱼ is the total noise received by the user j; and n*ⱼ denotes the conjugate of nⱼ.

The decoding order refers to a successive interference cancellation sequence specified by the NOMA network for each user. The decoding order may be determined based on wireless communication protocols (e.g., LTE, 5G, etc.).

The total noise refers to a combined value (e.g., the power sum) of all interference and additive noise received by the user. The total noise may be obtained by measurement.

The reflective phase shift constraint refers to a constraint on a phase change for each reflection unit of the IRS. For example, the reflective phase shift constraint may be that the reflection coefficient modulus of each reflection unit is 1. In some embodiments, the reflective phase shift constraint may be expressed as C3, with C3 satisfying the following equation:

$$C 3 : {\vert {e}_{l} \vert}^{2} = 1 , {e}_{l} ∈ e$$

where, eₗ denotes the l-th element of the passive beamforming vector e of the IRS.

The base station transmission power minimization model refers to an optimization model that minimizes the power of the signal transmitted from the base station. In some embodiments, the processor may use the equation corresponding to the user QoS constraint C1, the equation corresponding to the successive interference cancellation constraint C2, and the equation corresponding to the reflective phase shift constraint C3 as the base station transmission power minimization model.

In some embodiments, the base station transmission power minimization model may be expressed as the following equation:

$$\begin{matrix}{min}_{e , \{ {w}_{k} \}} {\sum }_{k = 1}^{K} {‖ {w}_{k} ‖}^{2} \\ s . t . C 1 : {R}_{k \to k} \geq {R}_{min} \\ C 2 : {R}_{j \to k} \geq {R}_{k \to k} , Ω ( j ) > Ω ( k ) \\ c 3 : {\vert {e}_{1} \vert}^{2} = 1 , {e}_{1} ∈ e\end{matrix}$$

where, K denotes a total count of the single-antenna users. More descriptions regarding meanings of C1, C2, C3, and equation notations may be found in above and related descriptions thereof.

The total count of the single-antenna users refers to a count of all single-antenna users in the hardware impairment-based IRS-assisted NOMA network system.

In some embodiments of the present disclosure, an IRS-assisted non-orthogonal multiple access model is constructed by taking into account that transceiver hardware aging, oscillator noise, and low-resolution digital-to-analog converters lead to impaired transmitting and receiving signal quality, and by taking into account the channel uncertainty that occurs in practical applications. The IRS-assisted non-orthogonal multiple access model can reflect the optimal transmission power results of multi-users assisted by non-orthogonal multiple access technology and the IRS, which realizes the low power transmission and minimizes the energy consumption while ensuring the robustness of the system, thus better aligning with practical application scenarios.

Step 130: solving the base station transmission power minimization model to obtain an optimal transmission scheme, and controlling the NOMA network system to transmit according to the optimal transmission scheme.

The optimal transmission scheme refers to a transmission scheme that minimizes a total transmit power of the base station and has a best transmission effect. In some embodiments, the optimal transmission scheme may include instructions on how the base station sends signals, how the IRS adjusts reflections, or the like.

In some embodiments, the processor may fix the passive beamforming vector of the IRS, solve for the active beamforming vector; fix the active beamforming vector, update the passive beamforming vector of the IRS; iterate in a loop until the total transmit power of the base station converges, and output the active beamforming vector wₖ and the passive beamforming vector e of the IRS as the optimal transmission scheme.

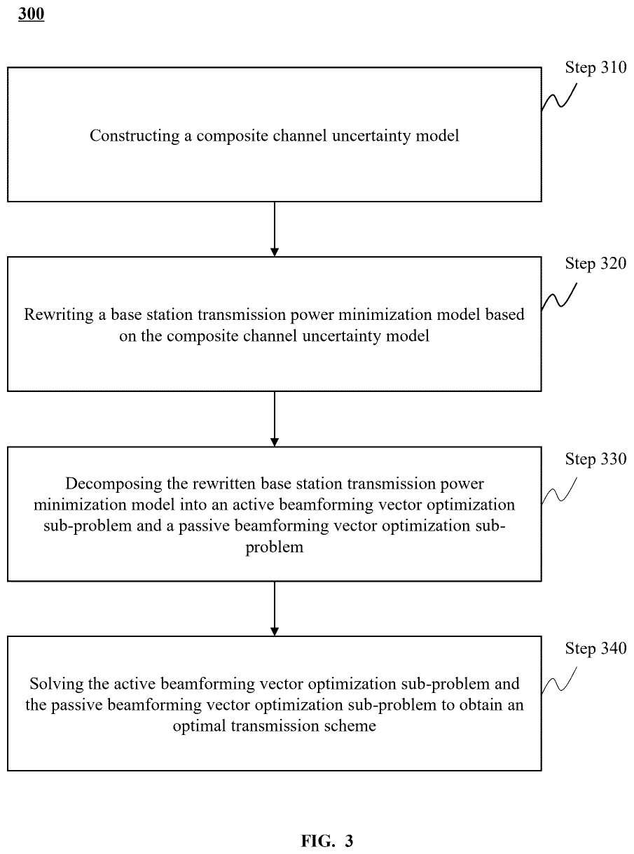

In some embodiments, the processor may construct a composite channel uncertainty model; rewrite the base station transmission power minimization model based on the composite channel uncertainty model; and decompose the rewritten base station transmission power minimization model into an active beamforming vector optimization sub-problem and a passive beamforming vector optimization sub-problem; solve the active beamforming vector optimization sub-problem and the passive beamforming vector optimization sub-problem to obtain the optimal transmission scheme. The present embodiment takes into account that channel uncertainty is unavoidable in practical applications. Therefore, during establishing the transmission power minimization model, channel uncertainty is considered and modeled as an additive model, ultimately determining the composite channel uncertainty model. More descriptions may be found in FIG. 3 and related descriptions thereof.

FIG. 3 is a flowchart of an exemplary process for determining an optimal transmission scheme according to some embodiments of the present disclosure. Process 300 refers to an exemplary process for determining the optimal transmission scheme. As shown in FIG. 3, the process 300 includes steps 310-340. In some embodiments, the process 300 may be executed by the processor. Steps 310-340 are shown below.

Step 310: constructing a composite channel uncertainty model.

The composite channel uncertainty model refers to a model that reflects uncertainty of a composite channel during signal transmission.

In some embodiments, the processor may construct the composite channel uncertainty model based on a composite channel matrix of a user, an estimation value of the composite channel matrix, an estimation error of the composite channel matrix, and a radius value of an error region.

In some embodiments, the composite channel uncertainty model may be expressed as:

$$\begin{matrix}{H}_{k} = {\hat{H}}_{k} + Δ {H}_{k} \\ {‖ Δ {H}_{k} ‖}_{F} \leq {ξ}_{h , k}\end{matrix} \}$$

where, Hₖ denotes the composite channel matrix from the BS to the user k, Ĥₖ denotes the estimation value of the composite channel matrix, ΔHₖ denotes the estimation error of the composite channel matrix, and ξ_{h,k} denotes the radius value of the error region.

The composite channel matrix of the user refers to an actual total channel of the signal from the base station to the user. The composite channel matrix of the user refers to a superposition of a plurality of channels of the signal from the base station to the user. The composite channel of the user reflects the overall transmission characteristics of the signal from the base station to the user.

The estimation value of the composite channel matrix refers to a prediction value of the composite channel matrix. The estimation value of the composite channel matrix may be determined by a preset algorithm. The preset algorithm may be Pilot Signal estimation, Least Squares (LS), etc., without limitation here.

The estimation error of the composite channel matrix refers to an error between the estimation value of the composite channel matrix and an actual value.

The radius value of the error region refers to a range of the estimation error of the composite channel matrix. The radius value of the error region may be set empirically.

Step 320: rewriting a base station transmission power minimization model based on the composite channel uncertainty model.

In some embodiments, the processor may adjust the composite channel matrix of the user based on the composite channel uncertainty model; and update the base station transmission power minimization model based on an adjusted composite channel matrix of the user.

In some embodiments, the base station transmission power minimization model may be rewritten as:

$$\begin{matrix}{min}_{e , {\{ {w}_{k} \}}_{j} , {η}_{h} , {μ}_{h}} {\sum }_{k = 1}^{K} {‖ {w}_{k} ‖}^{2} \\ s . t . C 2 , C 3 \\ C 4 : [ \begin{matrix}{η}_{h , k} {I}_{( L \times N )} + {A}_{k , k} & {a}_{k , k} \\ {a}_{k , k}^{T} & {C}_{k}\end{matrix} ] \geq 0 \\ C 5 : [ \begin{matrix}{λ}_{k} - ( 1 + {α}_{a , k} ) {σ}^{2} & {e}^{H} {\hat{H}}_{k} {ω}_{k} & {0}_{1 \times N} \\ {ω}_{k}^{H} e {\hat{H}}_{k}^{H} & {I}_{( K - k )} & {ξ}_{h , k} {ω}_{k}^{H} \\ {0}_{N \times 1} & {ξ}_{h , k} {ω}_{k} & {μ}_{h , k} {I}_{N}\end{matrix} ] \geq 0 \\ C 6 : {η}_{h} \geq 0 , {μ}_{h} \geq 0\end{matrix}$$

where ηₕ=[η_{h,1}, . . . , η_{h,K}]^{T}≥0 denotes a first relaxation variable, η_{h,k} denotes a first relaxation variable of the user k, μₕ=μ_{h,1}, . . . , μ_{h,K}]^{T}≥0 denotes a second relaxation variable, μ_{h,k} denotes a second relaxation variable of the user k; I_{(L×N)} denotes a unit matrix of order L×N, A_{k,k}, a_{k,k}, and Cₖ denote a first intermediate parameter, a second intermediate parameter and a third intermediate parameter, respectively, and A_{k,k}, a_{k,k}, and Cₖ denote designators in a linear approximation process, which are not physically meaningful; dak denotes a scaling coefficient of HWI at the receiving end of the user k, λₖ denotes an interference-plus-noise power of the user k, δ denotes a variance of Gaussian white noise, ωₖ denotes the active beamforming matrix, 0_{1×N} denotes a zero matrix of order 1×N, I_{(K-k)} denotes a unit matrix of order K-k, and I_{N} denotes a unit matrix of order N×N. More descriptions regarding the meanings of Ĥₖ, ξ_{h,k}, C2, C3, and the equation notations may be found in above and related descriptions thereof.

The scaling coefficient of the HWI refers to a value configured to measure a severity of signal distortion or noise in a receiving device due to hardware defects.

C4 refers to a constraint on the first intermediate parameter, the second intermediate parameter, and the third intermediate parameter. C5 refers to a constraint on signal transmission situation of the composite channel matrix. C6 refers to a constraint on the first relaxation variable and the second relaxation variable.

The first relaxation variable and the second relaxation variable refer to auxiliary variables introduced during an optimization process to relax non-convex constraints of the original problem. The first relaxation variable and the second relaxation variable may be empirically preset.

The interference-plus-noise power refers to a sum of all unexpected signal power received by the user and Gaussian white noise power. In some embodiments, the processor may obtain an unexpected signal fed back from the user via the user terminal and calculate the total power. The Gaussian white noise power may be obtained by measurement.

Step 330: decomposing the rewritten base station transmission power minimization model into the active beamforming vector optimization sub-problem and the passive beamforming vector optimization sub-problem.

Using an idea of alternate optimization to solve a variable coupling problem, the rewritten base station transmission power minimization model is divided into two optimization sub-problems, i.e., the active beamforming vector optimization sub-problem {wₖ} and the passive beamforming vector optimization sub-problem e.

The active beamforming vector optimization sub-problem refers to a sub-problem in which the active beamforming vector is optimized to minimize the base station transmission power when transmitting the signal.

In some embodiments, the processor may determine the active beamforming vector optimization sub-problem based on the total count of users, the active beamforming vector, the first relaxation variable, and the second relaxation variable.

In some embodiments, the active beamforming vector optimization sub-problem may be expressed as:

$$\begin{matrix}{min}_{\{ {w}_{k} \} , {η}_{h} , {μ}_{h}} {\sum }_{k = 1}^{K} {‖ {w}_{k} ‖}^{2} \\ s . t . C 2 , C 4 , C 5 , C 6\end{matrix}$$

More descriptions regarding C2-C6 may be found in above and related descriptions thereof.

The passive beamforming vector optimization sub-problem refers to a sub-problem in which the passive beamforming vector is optimized to minimize the base station transmission power when receiving the signal.

In some embodiments, the processor may determine the passive beamforming vector optimization sub-problem based on a signal-to-interference-plus-noise ratio (SINR) residual matrix, a SINR residual, the passive beamforming vector, the first relaxation variable, and the second relaxation variable.

In some embodiments, the passive beamforming vector optimization sub-problem may be expressed as:

$$\begin{matrix}{max}_{e , {η}_{h} , {μ}_{h} , p} {\sum }_{k = 1}^{K} {p}_{k} \\ s . t . C 3 , C 4 , C 5 , C 6 \\ C 8 : p \geq 0 \\ C 9 : ln ( {\vert {e}^{H} {H}_{k} {w}_{k} \vert}^{2} ) - ln ( {\sum }_{Ω ( i ) > Ω ( k )} {\vert {e}^{H} {H}_{k} {w}_{i} \vert}^{2} + {Λ}_{k} ) \\ - ln ( {\vert {e}^{H} {H}_{j} {w}_{k} \vert}^{2} ) + ln ( {\sum }_{Ω ( i ) > Ω ( k )} {\vert {e}^{H} {H}_{j} {w}_{j} \vert}^{2} + {Λ}_{j} ) \leq 0 , Ω ( j ) > Ω ( k )\end{matrix}$$

where, the p=[p₁, . . . , p_{K}]^{T} denotes the SINR residual matrix, pₖ denotes the SINR residual of the user k, Ak denotes the total noise power of the user k, and Hⱼ denotes the composite channel matrix from the BS to the user j. λⱼ denotes the total noise power of the user j. More descriptions regarding C3-C6 may be found in above and related descriptions thereof.

C8 refers to a constraint on the SINR residual matrix, and C9 refers to a constraint on a noise interference situation when different users receive signals.

Step 340: solving the active beamforming vector optimization sub-problem and the passive beamforming vector optimization sub-problem to obtain the optimal transmission scheme.

In some embodiments, solving the active beamforming vector optimization sub-problem and the passive beamforming vector optimization sub-problem to obtain the optimal transmission scheme may include: in the active beamforming vector optimization sub-problem, transforming a non-convex term C2 by linear approximation and successive convex approximation (SCA) manners to obtain a standard semidefinite programming (SDP) problem, and obtaining an active beamforming vector value based on the standard semidefinite programming problem using a convex optimization toolbox; in the passive beamforming vector optimization sub-problem, transforming the non-convex term C2 using a penalty convex-concave procedure (PCCP) algorithm to obtain a convex optimization problem, and determining a passive beamforming vector value based on the convex optimization problem using the convex optimization toolbox; and iteratively solving the active beamforming vector optimization sub-problem and the passive beamforming vector optimization sub-problem to obtain the optimal transmission scheme in an alternating optimization framework.

In some embodiments, the standard semidefinite programming problem may be expressed as:

$$\begin{matrix}{max}_{\{ {w}_{k} \} , {η}_{h} , {μ}_{h}} {\sum }_{k = 1}^{K} {‖ {w}_{k} ‖}^{2} \\ s . t . C 4 , C 5 , C 6 \\ C 9 : ln ( {\vert {e}^{H} {H}_{k} {w}_{k} \vert}^{2} ) - ln ( {\sum }_{Ω ( i ) > Ω ( k )} {\vert {e}^{H} {H}_{k} {w}_{i} \vert}^{2} + {Λ}_{k} ) \\ - ln ( {\vert {e}^{H} {H}_{j} {w}_{k} \vert}^{2} ) + ln ( {\sum }_{Ω ( i ) > Ω ( k )} {\vert {e}^{H} {H}_{j} {w}_{i} \vert}^{2} + {Λ}_{j} ) \leq 0 , Ω ( j ) > Ω ( k )\end{matrix}$$

More descriptions regarding meanings of the equation notations may be found in above and related descriptions thereof.

In some embodiments, the processor may solve the standard semidefinite programming problem using the convex optimization toolbox to obtain a corresponding active beamforming vector {wₖ}.

The convex optimization toolbox refers to a collection of software for solving convex optimization problems. For example, the convex optimization toolbox may be CVX, MOSEK, SeDuMi, SDPT3, and Gurobi.

In some embodiments, the processor may obtain the convex optimization problem using the penalty convex-concave procedure algorithm for the non-convex term C2 in the passive beamforming vector optimization sub-problem.

The penalty convex-concave procedure algorithm refers to an optimization algorithm that introduces a penalty term after convex-concave decomposition to transform the non-convex problem into a series of convex sub-problems solved iteratively.

The convex optimization problem refers to an optimization problem in which both a target function and a feasible domain are convex, and the feasible domain refers to a set of values of all variables that satisfy given constraints.

In some embodiments, the convex optimization problem may be expressed as:

$$\begin{matrix}{max}_{e , {η}_{h} , {μ}_{h} , p , q} {\sum }_{k = 1}^{K} {p}_{k} - {χ}^{[ m ]} {\sum }_{l = 1}^{2 L} {q}_{l} \\ s . t . C 4 , C 5 , C 6 , C 8 , C 9 \\ {C 10 : \vert {e}_{l}^{[ m ]} ]}^{2} - 2 Re ( {e}_{l}^{*} {e}_{l}^{[ m ]} ) \leq {q}_{l} - 1 \\ C 11 : {\vert {e}_{1} \vert}^{2} \leq 1 + {q}_{L + 1} \\ C 12 : q ⩾ 0\end{matrix}$$

where q=[q₁, . . . , q_{2L}]^{T} denotes a relaxation variable with equivalent linear constraints, qₗ denotes a relaxation variable of an l-th equivalent linear constraint;

$${‖ q ‖}_{l} = {\sum }_{l = 1}^{2 L} {q}_{l}$$

denotes a penalty term in the target function; χ^{[m]} denotes a regularization factor that scales ∥q∥ₗ to control the feasibility of the constraints;

$${e}_{l}^{[ m ]}$$

denotes an m-in iteration of an l-th passive beamforming vector element, and

$${e}_{l}^{*}$$

denotes a conjugate of the l-th passive beamforming vector element, and q_{L+1} denotes a relaxation variable of a (L+1)-th equivalent linear constraint, Re denotes taking a real part.

C10 and C11 refer to constraints on the passive beamforming vector. C12 refers to a constraint on the relaxation variable of the equivalent linear constraints.

In some embodiments, the processor may calculate the passive beamforming vector based on the convex optimization problem using the convex optimization toolbox.

In some embodiments, the processor may obtain an optimal solution of the original problem by Iteratively solving the two optimization sub-problems in the alternating optimization framework. For example, the processor may solve for an optimal active beamforming vector by fixing the passive beamforming vector under the alternating optimization framework; solve for an optimal passive beamforming vector by fixing the optimal active beamforming vector obtained in a previous iteration; cycle through these iterations until the total transmit power of the base station converges to a preset stable value, and the iteration ends. The active beamforming vector at the end of the iteration is the active beamforming vector optimization sub-problem, and the passive beamforming vector at the end of the iteration is the passive beamforming vector optimization sub-problem, and together they form the optimal transmission scheme composed of the active beamforming vector optimization sub-problem and the passive beamforming vector optimization sub-problem.

In some embodiments of the present disclosure, the active beamforming vector optimization sub-problem is transformed into the standard semidefinite programming problem via the linear approximation and the successive convex approximation manners, which can be efficiently solved by directly invoking the convex optimization toolbox. Meanwhile, in the passive beamforming vector optimization sub-problem, the penalty convex-concave procedure algorithm is adopted to convert the non-convex term into a convex form, which is also solved using the convex optimization toolbox. Ultimately, the optimal solution to the original problem is finally obtained iteratively in the alternating optimization framework, significantly reducing computational complexity while ensuring convergence.

In some embodiments, the processor may set the active beamforming vector wₖ as transmit beam weights for each user and configure the phases of all reflection units according to the calculated passive beamforming vector e of the IRS. Communication is then initiated, controlling the base station to transmit the signals based on the transmit beam weights and the phase of the reflection units, and decode the signals according to the specified successive interference cancellation (SIC) order.

In some embodiments of the present disclosure, the IRS-assisted NOMA model is constructed by considering factors such as transceiver hardware aging, oscillator noise, and low-resolution digital-to-analog converters that impair transmitted and received signal quality, as well as accounting for channel uncertainty encountered in practical applications. This model can reflect the optimal transmission power results for multi-users assisted by non-orthogonal multiple access technology and the IRS. By incorporating HWI and imperfect CSI constraints, it achieves low-power transmission while minimizing energy consumption and ensuring system robustness, thereby better aligning with practical application scenarios.

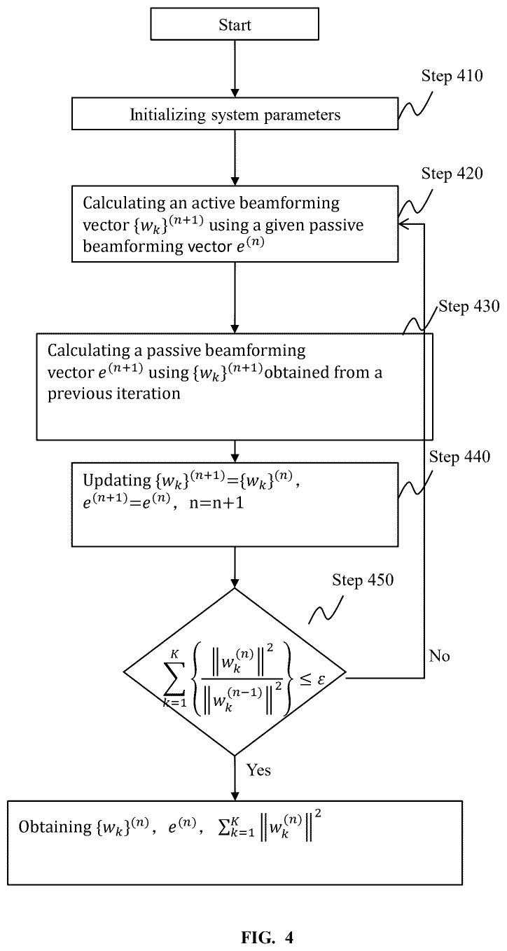

FIG. 4 is another flowchart of an exemplary process for determining an optimal transmission scheme according to some embodiments of the present disclosure.

In some embodiments, due to the estimation error and unknown hardware impairments in the composite channel, the active beamforming vector optimization sub-problem and passive beamforming vector optimization sub-problem are non-convex and difficult to solve. Therefore, alternating iteration is employed to decouple the coupled variables and perform successive convex approximation, quickly obtaining a low-power and robust optimal transmission scheme. In some embodiments, each round of iteration includes steps 410-steps 450.

Step 410, initializing system parameters.

In some embodiments, the system parameters may include a count of single-antenna users k, a count of base station antennas N, a count of IRS array elements L, a channel G from the base station to the IRS, a channel h_{d,k} from the base station to the user k, a channel h_{r,k} from the IRS to the user k, the estimation value of the composite channel Ĥₖ, the estimation error of the composite channel ΔHₖ, the phase shift matrix of the IRS ϕ, the active beamforming vector {wₖ}, the passive beamforming vector e, and a convergence accuracy ε.

In some embodiments, the processor may perform an iterative initialization to set an initial passive beamforming vector e⁽⁰⁾ and an initial active beamforming vector {wₖ}⁽⁰⁾. The value of e⁽⁰⁾ and {wₖ}⁽⁰⁾ may be set empirically. The convergence accuracy ε of the iteration may be set to 10⁻⁶. More descriptions regarding e and {wₖ} may be found in above and related descriptions thereof, the convergence accuracy refers to a maximum allowable difference between values of two adjacent target function when the iteration stops.

Step 420, calculating an active beamforming vector {wₖ}⁽ⁿ⁺¹⁾ using a given the passive beamforming vector e⁽ⁿ⁾.

In some embodiments, the processor may calculate the active beamforming vector {wₖ}⁽ⁿ⁺¹⁾ from the given passive beamforming vector e (n) based on a solving process of the active beamforming vector optimization sub-problem.

Step 430, calculating a passive beamforming vector e⁽ⁿ⁺¹⁾ using {wₖ}⁽ⁿ⁺¹⁾ obtained from a previous iteration.

In some embodiments, the processor may calculate the passive beamforming vector e⁽ⁿ⁺¹⁾ using {wₖ}⁽ⁿ⁺¹⁾ obtained from the previous iteration based on a solving process of the passive beamforming vector optimization sub-problem.

Step 440, updating {wₖ}⁽ⁿ⁺¹⁾={wₖ}⁽ⁿ⁾, e⁽ⁿ⁺¹⁾=e⁽ⁿ⁾, n=n+1.

Step 450, judging whether the condition

$${\sum }_{k = 1}^{K} \{ \frac{{‖ {w}_{k}^{( n )} ‖}^{2}}{{‖ {w}_{k}^{( n - 1 )} ‖}^{2}} \} \leq ε$$

is satisfied, if the condition is met, outputting {wₖ]⁽ⁿ⁾, e⁽ⁿ⁾,

$${\sum }_{k = 1}^{K} {‖ {w}_{k}^{( n )} ‖}^{2} ;$$

otherwise, proceeding to step 420 to continue iterative update.

In some embodiments, simulation experiments are conducted by configuring parameters of the IRS-assisted NOMA network, and the method for transmission in hardware impairment-based IRS-assisted NOMA network is validated based on the simulation results.

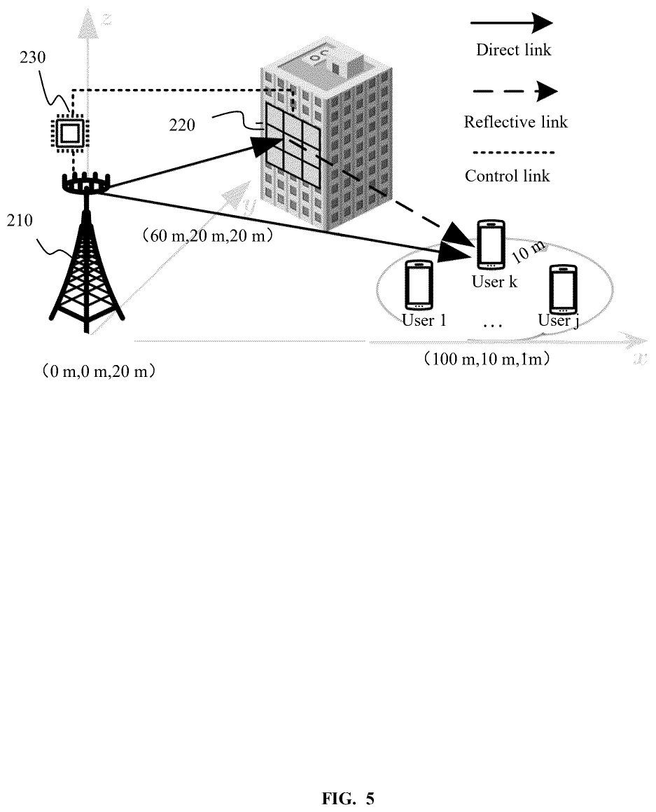

FIG. 5 is a schematic diagram of a simulation reference model according to some embodiments of the present disclosure.

In some embodiments, as shown in FIG. 5, simulation conditions include setting a count of base station antennas to 4, setting a count of intelligent reflecting surface units to 12, and setting a count of users to 8. Setting road loss indices from the base station to the IRS, the base station to the users, and the IRS to the users to be 3.5, 2.2, and 3.6, respectively. Channel bandwidth B=10 MHZ, the hardware damage coefficient α=0.02, Gaussian noise power n0=10 dBm. The coordinates of the base station antenna and the IRS in the system are located at (0 m, 0 m, 20 m) and (60 m, 20 m, 20 m), respectively, and user devices are randomly distributed in a circle centered at the coordinates (100 m, 10 m, 1 m) with a horizontal radius of 10 m.

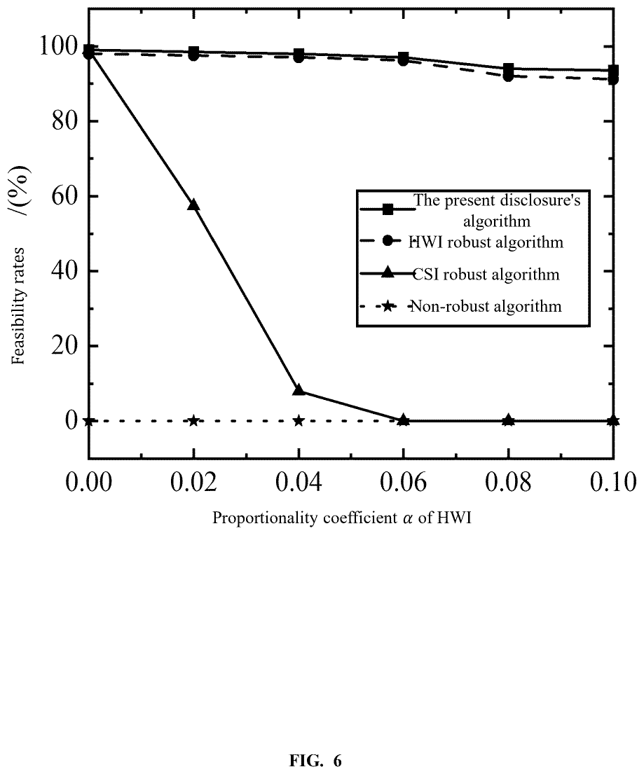

FIG. 6 is a schematic diagram of variations of feasibility rates of different algorithms with a scaling coefficient of HWI according to some embodiments of the present disclosure.

In some embodiments, as shown in FIG. 6, based on the simulation conditions, simulation experiments are conducted by the algorithm of the present disclosure (i.e., the method for transmission in a hardware impairment-based IRS-assisted NOMA network), a HWI robust algorithm, a CSI (channel state information) robust algorithm, and a non-robust algorithm, respectively, and variations of the feasibility rates corresponding to different algorithms with the scaling coefficient of the HWI may be obtained. The feasibility rate refers to a parameter reflecting the feasibility of the signal transmission for the IRS-assisted NOMA network system (also referred to as the system). In some embodiments, the feasibility rate may be a ratio of a count of channels that satisfy the user QoS constraint C1 to a total count of channels of the system. The feasibility rate may effectively characterize the robustness of the system. As shown in FIG. 6, the feasibility rates of the algorithm of the present disclosure, the HWI robust algorithm, and the CSI robust algorithm have different degrees of reduction as the scaling coefficient of the HWI increases, and the feasibility rate of the non-robust algorithm is always 0, but the feasibility rate of the algorithm of present disclosure is always greater than that of the HWI robust algorithm and the CSI robust algorithm.

In some embodiments, the processor may also control the antenna of the base station to change the signal frequency and the phase to form a beam of a fixed direction based on the active beamforming vector; control the IRS to adjust the reflection angles and the phase based on the passive beamforming vector; and transmit or reflect a carrier signal based on the signal frequency and the phase to transmit communication data to a communication terminal (i.e., the single-antenna user).

More descriptions regarding the active beamforming vector and the passive beamforming vector may be found in FIG. 1 and related descriptions thereof. More descriptions regarding the base station, the single-antenna user, the IRS may be found in FIG. 2 and related descriptions thereof.

The communication data refers to data of user requirements. In some embodiments, the processor may control the base station to convert the communication data into a carrier signal through modulation techniques, thereby enabling long-distance transmission over the air. The carrier signal refers to a high-frequency sinusoid configured to carrier information in a wireless communication.

The signal frequency refers to a count of times the antenna of the base station transmits a signal per unit of time. The phase refers to a transmitting state of the antenna of the base station. The phase of the base station includes poses and arrangements of a plurality of antennas. The signal frequencies and the phases of the plurality of antennas may be the same or different.

The fixed direction includes a direct direction and a reflection direction. The direct direction refers to a direction in which the base station directly transmits the communication data to the communication terminal, and the reflection direction refers to a direction in which the base station transmits the communication data to the reflection unit.

In some embodiments, the processor may adjust the signal frequency and the phase corresponding to each antenna separately based on the active beamforming vector. The signals emitted from the plurality of antennas interfere in space, thereby forming an enhanced beam (main lobe) in the fixed direction and attenuated enhanced beams (side lobes) in directions other than the fixed direction. In some embodiments, the processor may control the plurality of antennas of the base station to send the communication data directly to the communication terminal along a direct direction based on an adjusted signal frequency and an adjusted phase.

The reflection angle refers to an angle at which a wave beam is reflected to the communication terminal by the IRS. The phase of the IRS refers to a reflection state of the IRS. The phase of the IRS includes the poses and the arrangements of the plurality of reflection units. In some embodiments, the reflection angles and the poses of the plurality of reflection units may be the same or different.

In some embodiments, the processor may adjust the reflection angle and the pose of each reflection unit in the IRS based on the passive beamforming vector, respectively, so that the IRS may reflect the signals sent from the base station to the communication terminal.

In some embodiments, a transmission amount and a transmission rate of the communication data may be set based on experience or user requirements.

In some embodiments, the plurality of antennas of the base station may send the communication data to the IRS along the reflection direction based on the adjusted signal frequency and the adjusted phase; and the plurality of reflection units of the IRS may reflect the communication data to the communication terminal based on the adjusted reflection angle of the adjusted phase.

In some embodiments of the present disclosure, communication data is converted into directional beams with the fixed direction to reduce interference in other directions and enhance signal strength in the target direction, thereby decreasing communication loss and improving communication efficiency. Through the coordination of the plurality of antennas and the IRS of the base station, communication data can be transmitted to each communication terminal efficiently and energy-efficiently.

In some embodiments, the base station is configured with a damage monitoring sensor. In some embodiments, the processor may transmit measurement data obtained by the damage monitoring sensor to the base station via a feedback channel; determine a hardware damage coefficient of the base station through a hardware damage model based on the measurement data and device temperature data; and update the hardware damage coefficient of the base station.

The damage monitoring sensor refers to a sensor inside the base station that is configured to measure a degradation situation of hardware performance inside the base station. For example, the damage monitoring sensor power includes a power amplifier (PA) distortion detection circuit, an analog-to-digital converter (ADC) quantization noise measurement unit, etc.

The measurement data refers to a raw or preliminarily processed data stream collected by the damage monitoring sensor. The measurement data may reflect an operating state and performance metrics of the hardware monitored by the damage monitoring sensor. For example, the measurement data includes nonlinear error vectors of the power amplifier (PA), spectral noise density values of analog-to-digital converter (ADC) output signals, and instantaneous temperature readings.

The feedback channel refers to an internal communication bus, an interface, or a dedicated data link within the base station that transmits the measurement data from a sensor to the processor.

The device temperature data refers to a temperature of the hardware inside the base station. In some embodiments, the processor may obtain the device temperature data through periodic measurements by a temperature sensor (e.g., a thermistor or a digital temperature sensor) within the base station.

The hardware damage coefficient refers to a parameter for quantifying the impact of non-ideality of the base station hardware on signal quality. In some embodiments, the larger the hardware damage coefficient, the more severe the base station hardware distortion.

The hardware damage model refers to a model configured to output the hardware damage coefficient. In some embodiments, the hardware damage model is a machine learning model, e.g., a Deep Neural Network (DNN) model or the like.

In some embodiments, an input of the hardware damage model includes the measurement data and the device temperature data, and an input of the hardware damage model include the hardware damage coefficient.

In some embodiments, the hardware damage model may be obtained by training with a large number of training samples and labels corresponding to the training samples. In some embodiments, the processor may input a plurality of training samples with labels into an initial hardware damage model, construct a loss function based on the labels and results of the initial hardware damage model, and iteratively update parameters of the initial hardware damage model based on the loss function by gradient descent or other manner. In response to a determination that a preset training condition is met, the model training is completed, and a trained hardware damage model is obtained. The preset training condition may be that the loss function converges, a count of iterations reaches a count threshold, etc.

The training samples may include sample measurement data and sample device temperature data. The label refers to a sample hardware damage coefficient corresponding to the training sample. In some embodiments, the training samples and the labels may be obtained from experiment or historical data. For example, under experimental conditions corresponding to different training samples, the data transmission is carried out through the base station, and a high precision measurement device is configured to measure an error vector magnitude (EVM), an adjacent channel power ratio (ACPR), and a noise figure (NF). These measurements are used to assess the degree of hardware impairment, which is then assigned as the label to the training sample. The processor may collect a large number of training samples and corresponding labels by operating the base station under different states (e.g., applying varying power levels, simulating aging, or changing ambient temperature) in a controlled laboratory environment or during historical data transmission processes, using precise measurement manners such as high-precision instrumentation for EVM, ACPR, and noise figure.

In some embodiments, the processor may update the hardware damage coefficients output by the hardware damage model to new hardware damage coefficients for the base station.

In some embodiments of the present disclosure, the hardware damage coefficient is updated by integrating damage monitoring sensors with the hardware damage model. The damage monitoring sensors enable monitoring and quantification of hardware impairments across the entire communication link, including both the base station and communication terminals. By leveraging the measurement data from these sensors and the hardware damage model, the hardware damage coefficient of the base station can be optimized to more accurately reflect the actual physical performance of the system. Furthermore, based on changes in the hardware damage coefficient, the data transmission scheme can be promptly adjusted to enhance user experience and communication quality.

In some embodiments, the processor may also send a single-tone test signal to the communication terminal through a channel corresponding to the communication terminal during an idle transmission gap and receive a feedback signal returned from the communication terminal; measure an error vector amplitude and phase noise of the feedback signal through a spectrum analyzer (SA) or a vector signal analyzer (SA) configured in the base station based on the feedback signal; and evaluate a corresponding hardware damage coefficient of the communication terminal based on the hardware damage coefficients, the error vector amplitudes, and the phase noise of the base station measured at a plurality of time points.

The idle transmission gap refers to a blank time period reserved by the system without data transmission. In some embodiments, the idle transmission gap may be determined by a wireless communication protocol (e.g., LTE, 5G, etc.).

The channel corresponding to the communication terminal refers to a wireless communication link established between the base station and the communication terminal (e.g., the single-antenna user).

The single-tone test signal refers to an RF signal that contains only one fixed-frequency component (e.g., a pure sinusoidal wave). In some embodiments, the single-tone test signal is generated by a signal generator of the base station. Parameters such as frequency and power of the single-tone test signal may be set empirically by those skilled in the art.

The feedback signal refers to an RF signal fed back from the communication terminal that is related to the hardware damage of the communication terminal.

In some embodiments, after the communication terminal receives the single-tone test signal, the single-wave test signal may be processed by an RF front-end and a baseband processing circuit to generate the feedback signal, and the feedback signal is sent to the processor of the base station. In some embodiments, the communication terminal may also generate the feedback signal based on user feedback.

The error vector amplitude refers to an amplitude of a vector difference between an actual received symbol and an ideal reference symbol. The error vector amplitude may be configured to measure a quality of digital modulation signals. The actual received symbol refers to a digital symbol actually received by the base station. The ideal reference symbol refers to a digital symbol received by the base station under ideal conditions (e.g., when there is no hardware damage). The ideal reference symbol may be obtained experimentally.

In some embodiments, taking VSA as an example, the processor may digitize the feedback signal to obtain a digital signal; demodulate the digital signal based on a preset modulation type (e.g., QPSK, 16QAM) and synchronize time, frequency, and phase to obtain the actual received symbol; generate the ideal reference symbol based on an original bitstream corresponding to the digital signal and the preset modulation type; determine an error vector of the actual received symbol and the ideal reference symbol; and determine a ratio of a statistical value of all error vectors to a statistical value of all ideal reference symbols as the error vector amplitude. The statistical value may be a root mean square value, etc.

The phase noise is noise induced by random fluctuations in a phase of the carrier signal over time. In some embodiments, the processor may measure a noise power spectral density around a carrier corresponding to the feedback signal via the SA or VSA, and normalize the noise power spectral density to the phase noise.

The hardware damage coefficient corresponding to the communication terminal reflects the degree to which the hardware damage of the communication terminal affects the signal quality.

In some embodiments, the processor may preprocess the hardware damage coefficients, the error vector amplitudes, and the phase noise of the base station measured at the plurality of time points to obtain corrected hardware damage coefficients, corrected error vector amplitudes, and corrected phase noise of the base station; construct a feature vector based on the corrected hardware damage coefficients, the hardware damage coefficient, the corrected error vector amplitudes, and the corrected phase noise of the base station, retrieve a vector database, and take a reference hardware damage coefficient corresponding to a reference vector having the highest similarity to the feature vector as a hardware damage coefficient corresponding to the communication terminal. The similarity is negatively correlated with a vector distance, which may be a Euclidean distance or a cosine distance.

In some embodiments, the preprocessing includes averaging, filtering, or Kalman filtering. The preprocessing may eliminate effects of random factors such as rapid fading of the channel, transient interference, and other random factors to obtain more stable data.

In some embodiments, the vector database includes a plurality of reference vectors and the reference hardware damage coefficients corresponding to the reference vectors. The reference vectors may be constructed from historical hardware damage coefficients, historical error vector amplitudes, and historical phase noise of the base station in the historical data. The reference hardware damage coefficients may be obtained from actual measurements and evaluations.

In some embodiments of the present disclosure, by sending the single-tone test signal to a terminal during the idle transmission gap and collecting feedback of the terminal at the plurality of time points, measuring and calibrating the EVM of the terminal and the phase noise using the VSA, and then evaluating the hardware damage coefficient QUE of the terminal based on the vector database, the real-time coefficient is instantly written into the register of the base station and used for subsequent power optimization, so that a transmission scheme always matches a real hardware state of the terminal, thus significantly reducing the transmit power, improving the link robustness, and guaranteeing the user QoS, and at the same time avoiding misjudgment brought by channel fluctuation, thereby improving the stability and accuracy of the evaluation.

In some embodiments, the processor may also pre-allocate a plurality of communication time slots before transmitting the communication data through the base station; determine an estimated count of iterations for beamforming vectors (including the active beamforming vector and the passive beamforming vector) within each communication time slot; determine the optimal transmission scheme corresponding to the minimum transmission power of the base station based on the estimated count of the iterations for iterative optimization, the optimal transmission scheme including the data transmission amount and the transmission rate of the communication data; and control the antenna of the base station to transmit the communication data to the IRS and the communication terminal through the composite channel based on the data transmission amount and the transmission rate of communication data.

The communication time slot refers to a consecutive short time unit in the NOMA network system. In some embodiments, the processor may divide time resources in the NOMA network system into a plurality of communication time slots that are contiguous and have a preset length based on a wireless communication standard (e.g., a sub-frame and a time slot structure in 5G New Radio). The preset length may be preset by the user. The plurality of communication time slots may realize different functions during the signal transmission.

The estimated count of iterations refers to an estimated count that the NOMA network system iteratively updates relevant parameters (e.g., the active beamforming vector and the passive beamforming vector) when determining the optimal transmission scheme.

In some embodiments, the processor may obtain a latest hardware damage coefficient of the base station and a latest hardware damage coefficient of the communication terminal before the start of each communication time slot or during a real-time transmission process. The communication terminal obtains the feedback signal within the communication time slot. The channel state is determined based on the feedback signal within the communication time slot, the hardware damage coefficient of the base station, and the hardware damage coefficient of the communication terminal; and the estimated count of iterations is determined based on the channel state. More descriptions regarding the hardware damage coefficient of the base station, the hardware damage coefficient of the communication terminal, and the feedback signal may be found in above and related descriptions thereof.

The channel state refers to an indicator that comprehensively quantifies the current wireless link quality and characteristics. The channel state may be expressed as 0-1, with 0 indicating an extremely poor channel state and 1 indicating an excellent channel state. In some embodiments, the worse the channel state, the greater the estimated count of iterations.

In some embodiments, the processor may determine the EVM and the phase noise of the feedback signal within the communication time slot based on the feedback signal within the communication time slot by SA or VSA analysis; determine the channel state of the composite channel by retrieving a preset table based on the hardware damage coefficient of the base station, the hardware damage coefficient of the communication terminal, and the EVM and the phase noise of the feedback signal within the communication time slot. More descriptions regarding the EVM and the phase noise may be found in above and related descriptions thereof.

The preset table includes the hardware damage coefficient of the base station, the hardware damage coefficient of the communication terminal, the EVM and the phase noise of the feedback signal within the communication time slot, and the channel state corresponding the composite channel. In some embodiments, the preset table may be constructed based on historical detection data and historical communication data of the base station. The channel state of the preset table may be an actual measured channel state.

In some embodiments of the present disclosure, determining the channel state based on the hardware damage coefficient of the base station and the hardware damage coefficient of the terminal, the EVM, and the phase noise not only takes into account the wireless environment itself, but also takes into account the real hardware on sending and receiving ends of the data or signals, which makes the evaluated channel state more comprehensive and accurate. The channel state may characterize the overall health of the communication link, which in turn determines the convergence speed and difficulty of the optimization algorithm.

In some embodiments, the processor may determine the baseline beamforming vector based on the hardware damage coefficient of the base station and the hardware damage coefficient of the communication terminal, the channel state by searching a communication database; and iteratively optimize the beamforming vectors (including the active beamforming vector and the passive beamforming vector) based on the baseline beamforming vector through the estimated count of iterations.

The baseline beamforming vector refers to a beamforming vector and an initial value of the beamforming vector that best matches a current channel state and hardware damage conditions (including the active beamforming vector and the passive beamforming vector). The baseline beamforming vector may be used as a starting point for an iterative optimization process.

In some embodiments, the communication database includes the hardware damage coefficient of the base station, the hardware damage coefficient of the communication terminal, the channel state, and the baseline beamforming vector corresponding to the channel state. The communication database may be obtained based on historical communication data or experiments.

In some embodiments of the present disclosure, by using the communication database to retrieve a matched baseline beamforming vector as a good initial point for the optimization algorithm, the optimization iterations may start from a position very close to the optimal solution, thereby significantly reducing the count of iterations required to achieve satisfactory performance. The reduced count of iterations translates directly into a shorter optimization computation time, allowing the base station to generate and apply the optimal transmission scheme faster, thus reducing the system decision latency, and ensuring that the beam may be adjusted in time to avoid drastic changes in performance when the channel changes rapidly.

In some embodiments, the processor may iteratively update the active beamforming vector and the passive beamforming vector based on the estimated count of iterations to determine the optimal transmission scheme corresponding to the minimum transmission power of the base station; modulate the communication data (e.g., QPSK, 16QAM, etc.) based on the data transmission amount and the transmission rate of communication data in the optimal transmission scheme; and determine a radio frequency (RF) signal through a preset conversion algorithm (e.g., digital-to-analog convert (DAC), up-conversion circuit, etc.) based on modulated communication data. More descriptions regarding specific determination process for the optimal transmission scheme may be found in FIG. 1 to FIG. 6 and related descriptions thereof.

In some embodiments, the processor may determine the signal frequency and the phase of the plurality of antennas of the base station and control the plurality of antennas to transmit the RF signals through the composite channel to the communication terminals and IRS according to the signal frequency and the phase based on the active beamforming vector; and determine the reflection angles and the phases of the plurality of reflection units of the IRS and control the plurality of antennas to reflect the RF signals to the communication terminal based on the passive beamforming vector in the RF signals.

In some embodiments, during a communication process, in response to a determination that the data transmission amount of the communication data is greater than a preset transmission amount threshold, the communication data is divided into a plurality of pieces of sub-communication data, and the plurality of pieces of sub-communication data are transmitted continuously in the plurality of communication time slots, respectively.

In some embodiments of the present disclosure, adaptive adjustment is performed based on real-time channel states (incorporating hardware impairments and signal quality). This means that when channel states are favorable and change slowly, the count of iterations can be reduced to decrease computational load and conserve processing resources. Conversely, when channel states are poor and change rapidly, the count of iterations is increased to ensure optimization quality, thereby maximizing communication performance under limited real-time computational resources. This approach reduces the real-time processing burden: by avoiding always executing the maximum count of iterations regardless of circumstances, it significantly lowers the real-time computational load and power consumption of the base station in dynamic environments.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or collocation of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer-readable program code embodied thereon.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by +20%. Correspondingly, in some embodiments, the numerical parameters used in the description and claims are approximate values, and the approximate values may be changed according to the required characteristics of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A method for transmission in a hardware impairment-based intelligent reflecting surface (IRS)-assisted non-orthogonal multiple access (NOMA) network, comprising:
constructing an NOMA network system assisted by an IRS;
constructing a base station transmission power minimization model based on a user quality of service (QOS) constraint, a successive interference cancellation (SIC) constraint, and a reflective phase shift constraint; and
solving the base station transmission power minimization model to obtain an optimal transmission scheme, and controlling the NOMA network system to transmit according to the optimal transmission scheme; including:
constructing a composite channel uncertainty model, which is represented as:
$$\begin{matrix}{H}_{k} = {\hat{H}}_{k} + Δ {H}_{k} \\ {‖ Δ {H}_{k} ‖}_{F} \leq {ξ}_{h , k}\end{matrix} \}$$
wherein Hₖ denotes a composite channel matrix from a base station to a user k, Ĥₖ denotes an estimation value of the composite channel matrix, ΔHₖ denotes an estimation error of the composite channel matrix, and ξ_{h,k} denotes a radius value of an error region;
rewriting the base station transmission power minimization model based on the composite channel uncertainty model;
decomposing the rewritten base station transmission power minimization model into an active beamforming vector optimization sub-problem and a passive beamforming vector optimization sub-problem;
the active beamforming vector optimization sub-problem being expressed as:
$$\begin{matrix}{min}_{\{ {w}_{k} \} , {η}_{h} , {μ}_{h}} {\sum }_{k = 1}^{K} {‖ {w}_{k} ‖}^{2} \\ s . t . C 2 : {R}_{j \to k} \geq {R}_{k \to k} , Ω ( j ) \geq Ω ( k ) \\ C 4 : [ \begin{matrix}{η}_{h , k} {I}_{( L \times N )} + {A}_{k , k} & {a}_{k , k} \\ {a}_{k , k}^{T} & {C}_{k}\end{matrix} ] ≽ 0 \\ C 5 : [ \begin{matrix}{λ}_{k} - ( 1 + {α}_{a , k} ) {δ}^{2} & {e}^{H} {\hat{H}}_{k} {ω}_{k} & {0}_{1 \times N} \\ {ω}_{k}^{H} e {\hat{H}}_{k}^{H} & {I}_{( K - k )} & {ξ}_{h , k} {ω}_{k}^{H} \\ {0}_{N \times 1} & {ξ}_{h , k} {ω}_{k} & {μ}_{h , k} {I}_{N}\end{matrix} ] ≽ 0 \\ C 6 : {η}_{h} \geq 0 , {μ}_{h} \geq 0\end{matrix}$$
wherein wₖ denotes an active beamforming vector sent by the base station to the user k, K denotes a total count of users, R_{k→k} denotes a decoding rate at which the user k decodes its own signal, R_{j→k} denotes a decoding rate at which a user j decodes the signal of the user k, Ω(j) denotes a decoding order of the user j, Ω(k) denotes a decoding order of the user k, I_{(L×N)} denotes a unit matrix of order L×N, A_{k,k}, a_{k,k} and Cₖ denote a first intermediate parameter, a second intermediate parameter, and a third intermediate parameter, respectively, a_{a,k} denotes a scaling coefficient of hardware impairment (HWI) at a receiving end of the user k, λₖ denotes an interference-plus-noise power of the user k, δ denotes a variance of Gaussian white noise, e denotes a passive beamforming vector of the IRS, Ĥₖ denotes the estimation value of the composite channel matrix, ωₖ denotes an active beamforming matrix, 0_{1×N} denotes a zero matrix of order 1×N, I_{(K-k)} denotes a unit matrix of order K-k, ξ_{h,k} denotes the radius value of the error region, I_{N} denotes a unit matrix of order N×N, ηh=[η_{h,1}, . . . η_{h,K}]^{T}≥0 denotes a first relaxation variable, η_{h,k} denotes a first relaxation variable for the user k, ηₕ=[μ_{h,1}, . . . , μ_{h,K}]^{T}≥0 denotes a second relaxation variable, μ_{h,k} denotes a second relaxation variable for the user k;
the passive beamforming vector optimization sub-problem being represented as:
$$\begin{matrix}{max}_{e , {η}_{k} , {μ}_{k} , p} {\sum }_{k = 1}^{K} {p}_{k} \\ s . t . C 3 : {\vert {e}_{l} \vert}^{2} = 1 = , {e}_{l} ∈ e \\ C 4 : [ \begin{matrix}{η}_{h , k} {I}_{( L \times N )} + {A}_{k , k} & {a}_{k , k} \\ {a}_{k , k}^{T} & {C}_{k}\end{matrix} ] ≽ 0 \\ C 5 : [ \begin{matrix}{λ}_{k} - ( 1 + {α}_{a , k} ) {δ}^{2} & {e}^{H} {\hat{H}}_{k} {ω}_{k} & {0}_{1 \times N} \\ {ω}_{k}^{H} e {\hat{H}}_{k}^{H} & {I}_{( K - k )} & {ξ}_{h , k} {ω}_{k}^{H} \\ {0}_{N \times 1} & {ξ}_{h , k} {ω}_{k} & {μ}_{h , k} {I}_{N}\end{matrix} ] ≽ 0 \\ C 6 : {η}_{h} ⩾ 0 , {μ}_{h} ⩾ 0 \\ C 8 : p ⩾ 0 \\ C 9 : ln ( {\vert {e}^{H} {H}_{k} {w}_{k} \vert}^{2} ) - ln ( {\sum }_{Ω ( i ) > Ω ( k )} {\vert {e}^{H} {H}_{k} {w}_{i} \vert}^{2} + {Λ}_{k} ) \\ - ln ( {\vert {e}^{H} {H}_{j} {w}_{k} \vert}^{2} + ln ( {\sum }_{Ω ( i ) > Ω ( k )} {\vert {e}^{H} {H}_{j} {w}_{i} \vert}^{2} + {Λ}_{j} ) \leq 0 , Ω ( j ) > Ω ( k )\end{matrix}$$
wherein pₖ denotes an SINR residual for the user k, e denotes the passive beamforming vector of the IRS, eₗ denotes an l-th element of the passive beamforming vector of the IRS, p denotes a SINR residual matrix, Hₖ denotes the composite channel matrix from the base station to the user k, wᵢ denotes an active beamforming vector sent by the base station to a user i, Λₖ denotes a total noise power of the user k, and Hⱼ denotes a composite channel matrix from the base station to the user j; and
solving the active beamforming vector optimization sub-problem and the passive beamforming vector optimization sub-problem to obtain the optimal transmission scheme.

2. The method according to claim 1, wherein the NOMA network system assisted by IRS includes: the base station equipped with a plurality of antennas, the intelligent reflecting surface (IRS), and a plurality of single-antenna users; and the intelligent reflecting surface (IRS) is equipped with a plurality of reflection units.

3. The method according to claim 1, wherein the base station transmission power minimization model is expressed as:
$$\begin{matrix}{min}_{e , \{ {w}_{k} \}} {\sum }_{k = 1}^{K} {‖ {w}_{k} ‖}^{2} \\ s . t . C 1 : {R}_{k \to k} \geq {R}_{min} \\ C 2 : {R}_{j \to k} ⩾ {R}_{k \to k} , Ω ( j ) ⩾ Ω ( k ) \\ C 3 : {\vert {e}_{l} \vert}^{2} = 1 , {e}_{l} ∈ e\end{matrix}$$
wherein wₖ denotes the active beamforming vector sent by the base station to the user k, K denotes the total count of users, e denotes the passive beamforming vector of the IRS, R_{k→k} denotes the decoding rate at which the user k decodes its own signal, Rₘᵢₙ denotes a user minimum rate threshold, R_{j→k} denotes the decoding rate at which the user j decodes the signal of the user k, Ω(j) denotes the decoding order of the user j, Ω(k) denotes the decoding order of the user k, eₗ denotes the l-th element of the passive beamforming vector of the IRS.

4. The method according to claim 1, wherein the solving the active beamforming vector optimization sub-problem and the passive beamforming vector optimization sub-problem to obtain the optimal transmission scheme includes:
in the active beamforming vector optimization sub-problem, transforming a non-convex term C2 by linear approximation and successive convex approximation (SCA) manners to obtain a standard semidefinite programming (SDP) problem, and obtaining an active beamforming vector value based on the standard semidefinite programming problem using a convex optimization toolbox;
in the passive beamforming vector optimization sub-problem, transforming the non-convex term C2 using a penalty convex-concave procedure (PCCP) algorithm to obtain a convex optimization problem, and determining a passive beamforming vector value based on the convex optimization problem using the convex optimization toolbox; and
iteratively solving the active beamforming vector optimization sub-problem and the passive beamforming vector optimization sub-problem to obtain the optimal transmission scheme in an alternating optimization framework.
